(19) United States
(12) Patent Application Publication
(10) Pub. No.: US 2009/0119357 A1
(43) Pub. Date: May 7, 2009

(54) ADVANCED CORRELATION AND PROCESS WINDOW EVALUATION APPLICATION

(75) Inventors: James P. Rice, Danbury, CT (US); Yunsheng Song, Poughkeepsie, NY (US); Yun-Yu Wang, Poughquag, NY (US); Chienfan Yu, Highland Mills, NY (US)

Correspondence Address: INTERNATIONAL BUSINESS MACHINES CORPORATION;DEPT. 18G, BLDG. 321-482, 2070 ROUTE 52, HOPEWELL JUNCTION, NY, 12533, US

(73) Assignee: International Business Machines Corporation, Armonk, NY (US)

(21) Appl. No.: 11/934,914

(22) Filed: Nov. 5, 2007

(51) Int. Cl. G06F 17/15

(52) U.S. Cl. 708/422

(57) ABSTRACT

A method only has the user input (or select) a data type, a report key, a dependent variable table, and/or filtering restrictions. Using this information, the method automatically locates independent variable data based on the data type and the report key. This independent variable data can be in the form of a table and comprises independent variables. The method automatically joins the dependent variable table and the independent variable data to create a joint table. Then, the method can automatically perform a statistical analysis of the joint table to find correlations between the dependent variables and the independent variables and output the correlations, without requiring the user to input or identify the independent variables.

### FIELD OF THE INVENTION

The embodiments of the invention generally relate to improving manufacturing processes, and more particularly to an improved method that simplifies statistical correlation processes by eliminating the need for the user to identify independent variables and which automatically identifies independent variables used in statistical analysis.

### BACKGROUND

With the fast pace progress of modern technologies, the process of scaling down, and the development of more complex devices and circuit designs, process control becomes more critical for yield learning. Process shifts of a few degrees Celsius or a micro-second could shift device performance significantly. Some of the challenging characteristics of manufacturing data analysis include multiple data types, large volumes, subtle device shifts, and data outliers. To detect and determine possible factors which can impact product quality, new applications of statistical techniques and automated analyses have been developed.

One of the objectives in manufacturing engineering is to understand the factors which can impact yield. Conventional methods for detecting the factors that affect yield are based on an engineer's experience or theories. Engineers select dependent variables (such as limited yields) and independent variables (such as some metrology data) to build up a table, then analyze the table by using a data mining tools or by building a scatter plot to see if there is a strong correlation between the identified dependent and independent variables.

These traditional methods sometimes do not account for all possible factors due to the limited experience or theories and the inordinately long times for manual data extraction. Further, such methods cannot cover large volumes of data and different data types, such as production line yield data, inline test data, and metrology data. Further, it is difficult to conventionally perform data manipulation using the common vertical databases. In addition, the manual selection of independent variables sometimes cannot respond fast enough to emerging problems which may have major revenue impact. In addition, such conventional systems are not very user friendly, because they require the user to be very experienced in statistical analysis and to have extensive knowledge of which dependent and independent variables will produce the most useful statistical correlations.

Therefore, the present embodiments provide a method that has the user only input (or select) a dependent variable table (comprising dependent variables), a data type, and a report key (and possibly filtering restrictions and statistical model selections). Using this information, the method automatically locates independent variable data based on the data type and the report key. This independent variable data can be in the form of a table and comprises independent variables. The method automatically joins the dependent variable table and the independent variable data to create a joint table. Then, the method can automatically perform a statistical analysis of the joint table to find correlations between the dependent variables and the independent variables and output the correlation results. This avoids having the user input or select the independent variables.

In addition, the method can automatically and independently filter the dependent variables and the independent variables (based on the filtering restrictions input by the user) to produce filtered dependent variables and filtered independent variables within the joint table. The filtering can comprise using different filters for the dependent variables and the independent variables. Similarly, the method can remove dependent variables and independent variables from the joint table that are based on a sample size that is below a predetermined minimum to maintain statistical quality.

As used herein, the dependent variables are related to product quality, yield, performance, etc., the independent variables are related to process parameters and inline electrical test parameters. The data type comprises different data sources and the report key comprises a module list or photo layer list of the data type. Either modules or photo layers can be used to point to specific process sectors.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a flow diagram illustrating a preferred method of an embodiment of the invention;

FIG. 2 is a dependent variable data table used with embodiment herein; and

FIG. 3 is a schematic diagram of a computer system for executing the embodiments herein.

### DETAILED DESCRIPTION OF EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

As mentioned above, traditional methods sometimes do not account for all possible factors due to the limited experience or theories and the inordinately long times for manual data extraction. Further, such methods cannot cover large volumes of data and different data types, such as production line yield data, inline test data, and metrology data. In addition, the manual selection of independent variables may not be able to respond fast enough to emerging problems. In addition, such conventional systems are not very user friendly, because they require the user to be very experienced in statistical analysis and to have extensive knowledge of which dependent and independent variables will produce the most useful statistical correlations.

Therefore, one idea of the invention is to have the user just supply an input table which has dependent variables and related categorical variables. This is different from traditional data mining systems which require the user to provide both dependent variables and independent variables. Therefore, with the invention, the user does not need to list, or even know, each of the independent variables. The user just needs to know which sector or part of the manufacturing process they want to focus on for data mining. With embodiments herein, the user just needs to identify the data type and data group (report key). The embodiments herein query all related independent variables automatically.

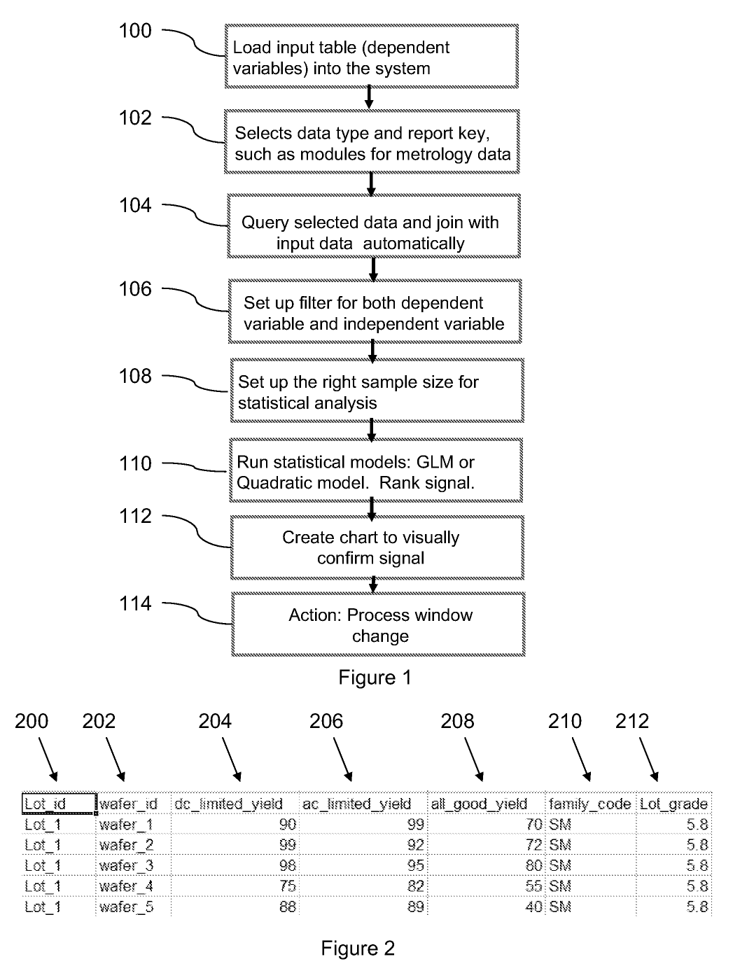

More specifically, as shown in flowchart form in FIG. 1, the present embodiments provide a method that has the user only input, in item 100, a dependent variable table (comprising dependent variables). A data type, and a report key (and possibly filtering restrictions and statistical algorithms selections) are selected by the user in item 102.

Using this information, the method automatically locates (queries areas of a database to find) independent variable data based on the data type and the report key in item 104, without further user input. This independent variable data can be in the form of a table and comprises independent variables. In item 104, the method also automatically (without further user input) joins the dependent variable table and the independent variable data to create a joint table.

In addition, the method can automatically and independently filter the dependent variables and the independent variables (based on the filtering restrictions input by the user) to produce filtered dependent variables and filtered independent variables within the joint table in item 106. With embodiments herein, the user is presented options to filter on any of the dependent variables in the input dataset and to filter independent variables automatically based on the distribution of each independent variable.

The filtering can comprise using different filters for the dependent variables and the independent variables. The dual filtering functions that occur in item 106 include different filters for dependent variable and for independent variables. The filters for the dependent variables can be based on both distribution of the variable and the other variables in the input table and can be determined by using a query builder. The filters for the independent variables can also be based on sigma rule. For example: if 3 sigma is selected, the data for independent variables out of 3 sigma will be filtered out of the analysis.

Similarly, the method can remove dependent variables and independent variables from the joint table that are based on a sample size that is below a predetermined minimum to maintain statistical quality in item 108. The minimum sample size function is used to eliminate dependent variables which have a smaller sample size than a minimum sample size. To eliminate false signals in statistical analysis, minimum sample sizes for independent variables are used.

Then, in item 110, the method can automatically perform a statistical analysis of the joint table to find correlations between the dependent variables and the independent variables and output the correlations results and rank the signals output by the statistical models. Thus, the models can be used to rank the signals to help the user pinpoint the most important signals. The most important signals can be further analyzed by using the correlation by time series.

The statistical models used with embodiments herein can include any models, whether now known or developed in the future. For example, the embodiments herein can use Generalized Linear Model (GLM) models and quadratic models. The GLM model is a linear model which can be used to rank signals based on R-squares. There are three options which can be used to do the analysis, positive correlation, negative correlation, and combination correlation. The positive correlation can be used to find the relationship between functional yield and inline test health of line yield. The negative correlation can be used to find relationships between functional yield and defect density. The combination correlation can be used for process window evaluation and abnormality identification. The quadratic model can be used to highlight a process which has significant quadratic shape and to evaluate if process windows are too wide or too narrow.

As part of the output, the invention can output various charts to visually confirm the signals output by the statistical models in item 112. This allows the user to take action to change various process windows in item 114 without having the user input or select the independent variables.

The system can be used efficiently with vertical database design and the user can control the sample size for statistical analysis. Further, multiple statistical models can be used to rank correlation results. The system can be used for process window evaluation, to detect abnormal process change, and for further physical failure analysis.

FIG. 2 illustrates one example of a dependent data table that can be supplied by the user. As would be understood by those ordinarily skilled in the art, the dependent data table could include any dependent variables and any categorical variables, which will vary from product to product and that FIG. 2 is only an example and that the invention is not limited to the example shown in FIG. 2.

In the example shown in FIG. 2, the dependent variables are the lot identification 200, the wafer identification 202, the family code 210, and the lot grade 212. In this example, the dependent variables include the DC limited yield 204, the AC limited yield 206, and the “all good” yield 208; the categorical variables include family code and lot grade. Users can create the dependent variable table by themselves or retrieve the data from a related database, such as functional test database or inline electrical test database.

The dependent variables are related to product quality, yield, performance, etc., while the independent variables are related to process parameters and process related measurement parameters. In other words, changes to the independent variables (e.g., changes in processing temperature, processing time, etc.) cause change in the dependent variables (e.g., the product yield or performance).

The data type comprises of different data sources and the report key comprises a module list or photo layer list of the data type. For example, some data types include metrology data, photo-limited yield (PLY) analysis, inline electrical data, or other related data types. The metrology data, photo-limited yield (PLY) analysis, inline electrical data, or other related data types are useful for vertical database design to make the system work efficiently. The data types can be used to identify independent variables automatically.

The processing herein is different from data mining systems which require the user to provide both dependent variables and independent variables. Therefore, with embodiments herein the user does not need to list, or even know, each of the independent variables. The user just needs to know which sector or part of the manufacturing process they want to focus on for data mining. The independent variable data can be retrieved automatically from a manufacturing database with embodiments herein.

The embodiments of the invention can take the form of an entirely hardware embodiment, an entirely software embodiment or an embodiment including both hardware and software elements. In a preferred embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

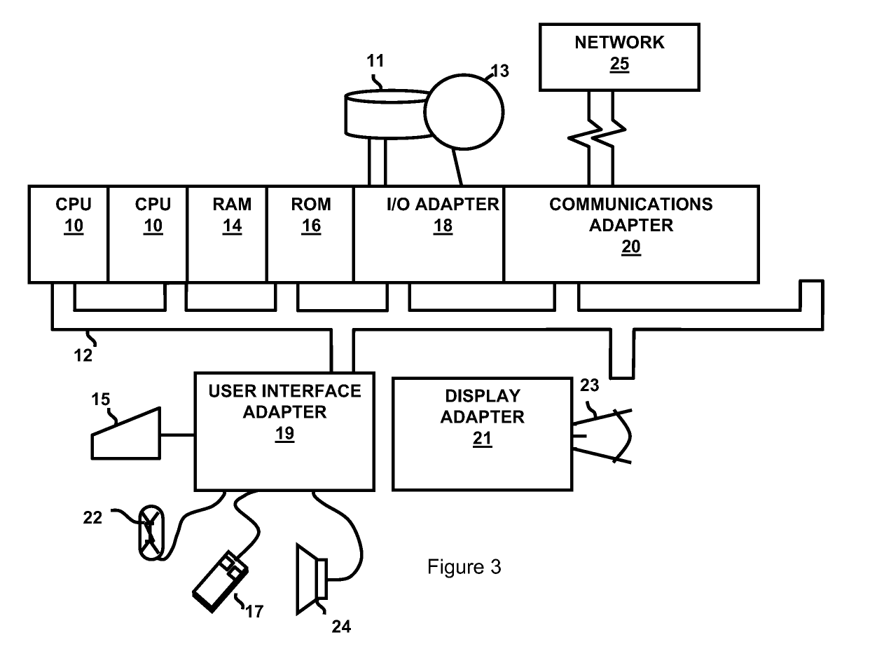

A representative hardware environment for practicing the embodiments of the invention is depicted in FIG. 3. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

What is claimed is:

1. A method comprising:
receiving a data type, a report key, and a dependent variable table comprising dependent variables;
automatically locating independent variable data based on said data type and said report key, wherein said independent variable data comprises independent variables;
automatically performing a statistical analysis to find correlation results between said dependent variables and said independent variables; and
outputting said correlation results.

2. The method according to claim 1, all the limitations of which are incorporated herein by reference, further comprising removing dependent variables and independent variables that are based on a sample size that is below a predetermined minimum.

3. The method according to claim 1, all the limitations of which are incorporated herein by reference, wherein said independent variables comprise variables related to process parameters and process related measurement parameters.

4. The method according to claim 1, all the limitations of which are incorporated herein by reference, wherein said dependent variables comprise variables related to at least one of product quality, yield, and performance.

5. The method according to claim 1, all the limitations of which are incorporated herein by reference, wherein said data type comprises a category of different data sources and said report key comprises a module list or photo layer list of said data type.

6. A method comprising:
receiving a data type, a report key, and a dependent variable table comprising dependent variables;
automatically locating independent variable data based on said data type and said report key, wherein said independent variable data comprises independent variables;
automatically joining said dependent variable table and said independent variable data to create a joint table;
automatically independently filtering said dependent variables and said independent variables to produce filtered dependent variables and filtered independent variables within said joint table;
automatically performing a statistical analysis of said joint table to find correlation results between said filtered dependent variables and said filtered independent variables; and
outputting said correlation results.

7. The method according to claim 6, all the limitations of which are incorporated herein by reference, further comprising removing dependent variables and independent variables from said joint table that are based on a sample size that is below a predetermined minimum.

8. The method according to claim 6, all the limitations of which are incorporated herein by reference, wherein said filtering comprises using different filters for said dependent variables and said independent variables.

9. The method according to claim 6, all the limitations of which are incorporated herein by reference, wherein said dependent variables comprise variables related to at least one of product quality, yield, and performance, and
wherein said independent variables comprise variables related to process parameters and process related measurement parameters.

10. The method according to claim 6, all the limitations of which are incorporated herein by reference, wherein said data type comprises a category of different data sources and said report key comprises a module list or photo layer list of said data type.

11. A method comprising:
receiving input from a user consisting of only:
a data type and a report key;
a dependent variable table comprising dependent variables; and
filtering restrictions;
automatically locating independent variable data based on said data type and said report key, wherein said independent variable data comprises independent variables;
automatically joining said dependent variable table and said independent variable data to create a joint table;
automatically independently filtering said dependent variables and said independent variables based on said filtering restrictions to produce filtered dependent variables and filtered independent variables within said joint table;
automatically performing a statistical analysis of said joint table to find correlation results between said filtered dependent variables and said filtered independent variables; and
outputting said correlation results.

12. The method according to claim 11, all the limitations of which are incorporated herein by reference, further comprising removing dependent variables and independent variables from said joint table that are based on a sample size that is below a predetermined minimum.

13. The method according to claim 11, all the limitations of which are incorporated herein by reference, wherein said filtering comprises using different filters for said dependent variables and said independent variables.

14. The method according to claim 11, all the limitations of which are incorporated herein by reference, wherein said dependent variables comprise variables related to at least one of product quality, yield, and performance, and
wherein said independent variables comprise variables related to process parameters and process related measurement parameters.

15. The method according to claim 11, all the limitations of which are incorporated herein by reference, wherein said data type comprises a category of different data sources and said report key comprises a module list or photo layer list of said data type.

16. A computer program product comprising a computer readable medium tangibly embodying a program of instructions executable by a computer, for performing a method comprising:
receiving a data type, a report key, and a dependent variable table comprising dependent variables;
automatically locating independent variable data based on said data type and said report key, wherein said independent variable data comprises independent variables;
automatically performing a statistical analysis to find correlation results between said dependent variables and said independent variables; and
outputting said correlation results.

17. The computer program product according to claim 16, all the limitations of which are incorporated herein by reference, further comprising removing dependent variables and independent variables that are based on a sample size that is below a predetermined minimum.

18. The computer program product according to claim 16, all the limitations of which are incorporated herein by reference, wherein said independent variables comprise variables related to process parameters and process related measurement parameters.

19. The computer program product according to claim 16, all the limitations of which are incorporated herein by reference, wherein said dependent variables comprise variables related to at least one of product quality, yield, and performance.

20. The computer program product according to claim 16, all the limitations of which are incorporated herein by reference, wherein said data type comprises a category of different data sources and said report key comprises a module list or photo layer list of said data type.
